(19) United States
(12) Patent Application Publication
(10) Pub. No.: US 2024/0244578 A1
(43) Pub. Date: Jul. 18, 2024

(54) SYSTEMS AND METHODS FOR LOCATION VERIFICATION

(71) Applicant: ZTE Corporation, Shenzhen (CN)

(72) Inventors: Fangyu CUI, Shenzhen (CN); Nan ZHANG, Shenzhen (CN); Wei CAO, Shenzhen (CN)

(73) Assignee: ZTE Corporation, Shenzhen (CN)

(21) Appl. No.: 18/617,453

(22) Filed: Mar. 26, 2024

Related U.S. Application Data
(63) Continuation of application No. PCT/CN2022/075979, filed on Feb. 11, 2022.

(51) Int. Cl. H04W 64/00; H04W 4/029

(52) U.S. Cl. CPC H04W 64/006; H04W 4/029

(57) ABSTRACT

Presented are systems and methods for location verification. A wireless communication device may send at least one message comprising assistance information for the wireless communication node to perform location verification. The assistance information may comprise time information.

### CROSS-REFERENCE TO RELATED APPLICATION

This application claims the benefit of priority under 35 U.S.C. § 120 as a continuation of PCT Patent Application No. PCT/CN2022/075979, filed on Feb. 11, 2022, the disclosure of which is incorporated herein by reference in its entirety.

### TECHNICAL FIELD

The disclosure relates generally to wireless communications, including but not limited to systems and methods for location verification.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. In one embodiment, a wireless communication device (e.g., user equipment) may send at least one message to a wireless communication node (e.g., base station). In some embodiments, the at least one message may comprise assistance information for the wireless communication node to perform location verification (e.g., of the user equipment). In some embodiments, the assistance information may comprise time information. In certain embodiments, the assistance information may further comprise at least one of trajectory information of the wireless communication device or mobility status of the wireless communication device. In some embodiments, the mobility status of the wireless communication device may comprise at least one of: a speed, a movement direction, a velocity vector, or an indication of speed range, of the wireless communication device. In some embodiments, the time information may comprise at least one of: a timing advance (TA) value, a round trip time (RTT) value, a single trip delay value, a difference between values associated with different reference points, or a time instant corresponding to generation of the assistance information.

In some embodiments, the wireless communication device may receive at least one of a position of a reference point for the location verification, a mobility status of a reference point for the location verification, an ephemeris of a satellite for the location verification, a trigger to initiate the location verification, a result of the location verification, at least one type of information to be reported by the wireless communication device to the wireless communication node, a reporting method for the wireless communication device to report the at least one type of information, a schedule for the wireless communication device to report the at least one type of information, a window for the location verification, or a maximum number of times for re-sending information comprising at least one of: the location information or the assistance information from the wireless communication node via at least one signaling. In some embodiments, the window for the location verification may comprise at least one of: a start time for the window, a duration of the window, or an end time for the window. In some embodiments, the at least one signaling may comprise: a radio resource control (RRC) signaling, or a system information block (SIB) signaling.

In some embodiments, the wireless communication device may receive an indication of a plurality of reference points from the wireless communication node; and send the assistance information comprising a plurality of time information each corresponding to a respective one of the plurality of reference points to the wireless communication node. In some embodiments, the wireless device may determine a first position of a first satellite according to an ephemeris of the first satellite; determine time information corresponding to the first position of the satellite according to the first position; and send the assistance information comprising the time information, corresponding to the first position of the first satellite, to the wireless communication node via the first satellite. In some embodiments, the wireless communication device may send the assistance information comprising time information, corresponding to a position of the second satellite to the wireless communication node via a second satellite; or send the assistance information comprising another time information, corresponding to a second position of the first satellite to the wireless communication node via the first satellite.

In some embodiments, the wireless communication device may receive a first indication if the location verification by the wireless communication node is successful from the wireless communication node; sends a second time information at a defined time, wherein the wireless communication node may perform a second location verification using the time information, the trajectory information and the mobility status in response to the first indication. In some embodiments, the defined time can refer to a time instant configured by the network or a pre-defined time instant known by both the UE and the network. In certain embodiments, the wireless may receive a second indication to send updated assistance information, if the second location verification is unsuccessful, from the wireless communication. In some embodiments, the wireless communication node may assign to the wireless communication device a first flag if the location verification by the wireless communication node is successful. In some embodiments, the wireless communication node may determine to skip subsequent local verification of the wireless communication device for at least one of: a defined period, or a duration of a connection with the wireless communication device.

In some embodiments, the wireless communication device may receive a trigger to initiate the location verification from the wireless communication node. In some embodiments, the wireless communication device may receive an indication of a plurality of reference points from the wireless communication node; determines a plurality of time information corresponding to the plurality of reference points; and send the plurality of time information, at a defined time, to the wireless communication node. In some embodiments, the defined time can refer to a time instant configured by the network or a pre-defined time instant known by both the UE and the network. In some embodiments, the wireless communication device may receive an indication of a plurality of time instants from the wireless communication node; and send a plurality of time information each at a respective time instant of the plurality of time instants to the wireless communication node in a periodic manner. In some embodiments, the wireless communication may determine a plurality of time information each corresponding to one of a plurality of time instants; and send the plurality of time information, at a defined time, to the wireless communication node. In some embodiments, the defined time can refer to a time instant configured by the network or a pre-defined time instant known by both the UE and the network. In some embodiments, the wireless communication device may determine a plurality of time information each corresponding to one of a plurality of time instants responsive to the trigger; and send the determined plurality of time information, at a defined time occurring after plurality of time instants, to the wireless communication node.

In some embodiments, the wireless communication device may predict a plurality of time information each corresponding to one of a plurality of time instants responsive to the trigger; and send the determined plurality of time information, at a defined time occurring prior to the plurality of time instants, to the wireless communication node. In some embodiments, the defined time can refer to a time instant configured by the network or a pre-defined time instant known by both the UE and the network. In certain embodiments, the plurality of time instants may be indicated by a start time and a period.

In some embodiments, within a time window prior to successful completion of the location verification, the wireless communication device may operate in a verification state during which the wireless communication device refrains from unilaterally transmitting to the wireless communication node. In some embodiments, the time window may start after the wireless communication device sends the first message and location information of the wireless communication device. In some embodiments, the time window may start responsive to a start or end time of the sending of the first message. In some embodiments, the time window may start at a time configured by the wireless communication node. In some embodiments, if the wireless communication device receives an indication that the location verification is successful or receives a scheduling for a transmission, determining, by the wireless communication device, to exit the verification state. In some embodiments, if the wireless communication device receives an indication that the location verification is unsuccessful, determining, by the wireless communication device, to: transition to idle mode, or re-send information comprising at least one of: the location information or the assistance information. In some embodiments, the wireless communication device may re-send the information until at least one of: the location verification has been attempted a defined number of times; or the time window has ended.

In some embodiments, if the wireless communication device may fail to receive a result of the location verification prior to an end of the time window, the method comprises one of: transitioning to an idle mode; re-sending information comprising at least one of: the location information or the assistance information; or resuming normal communication. In some embodiments, if the location verification is successful, the wireless communication node may at least one of: send an indication to the wireless communication device that the location verification is successful; or schedule a transmission with the wireless communication device. In some embodiments, if the location verification is unsuccessful, the wireless communication node may at least one of: send an indication to the wireless communication device that the location verification is unsuccessful; or configure or indicate the wireless communication device to re-send information comprising at least one of: the location information or the assistance information; or releases or terminates a connection with the wireless communication device.

In some embodiments, if the assistance information is not received prior to an end of the time window, the wireless communication node may at least one of: schedule a transmission with the wireless communication device; or if the location verification is unsuccessful, the wireless communication node may at least one of: release or terminate a connection with the wireless communication device; or configure or indicate the wireless communication device to re-send information comprising at least one of: the location information or the assistance information. In some embodiments, a start of the time window may be one of: predefined as a start or end time for the wireless communication device to send the location information, predefined as a time instant of triggering the location verification, predefined as a start or end time for the wireless communication device to send the assistance information, or configured via the wireless communication node. In some embodiments, a length of the time window may be one of: a value selected from at least one predefined values, or configured via the wireless communication node.

At least one aspect is directed to a system, method, apparatus, or a computer-readable medium. In some embodiments, a wireless communication node (e.g., a ground terminal, a base station, a gNB, an eNB, or a serving node) may receive at least one message comprising assistance information for the wireless communication node to perform location verification from a wireless communication device. In certain embodiments, the assistance information may comprise time information.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example transparent Non-Terrestrial Network (NTN), in accordance with some embodiments of the present disclosure;

FIG. 4A-4E illustrate related aspects of location verification, in accordance with some embodiments of the present disclosure;

FIG. 5 illustrates an example approach for location verification based on reported TA, in accordance with some embodiments of the present disclosure;

FIG. 6 illustrates an example approach for location verification based on configured reference points, in accordance with some embodiments of the present disclosure;

FIG. 7 illustrates trajectory and/or mobility status verification, in accordance with some embodiments of the present disclosure;

FIG. 8 illustrates an example approach for reporting time information corresponding to different reference points, in accordance with some embodiments of the present disclosure;

FIG. 9 illustrates an example approach for periodically reporting time information, in accordance with some embodiments of the present disclosure;

FIG. 10 illustrates an example approach for recording time information and reporting the time information, in accordance with some embodiments of the present disclosure;

FIG. 11 illustrates an example approach for recording time information after triggering, and reporting the time information, in accordance with some embodiments of the present disclosure;

FIG. 12 illustrates an example approach for predicting future time information after triggering, and reporting the time information, in accordance with some embodiments of the present disclosure;

FIG. 13 illustrates an example representation of a location verification window, in accordance with some embodiments of the present disclosure; and

FIG. 14 illustrates a flow diagram of an example method for location verification, in accordance with an embodiment of the present disclosure.

### DETAILED DESCRIPTION

### 1. Mobile Communication Technology and Environment

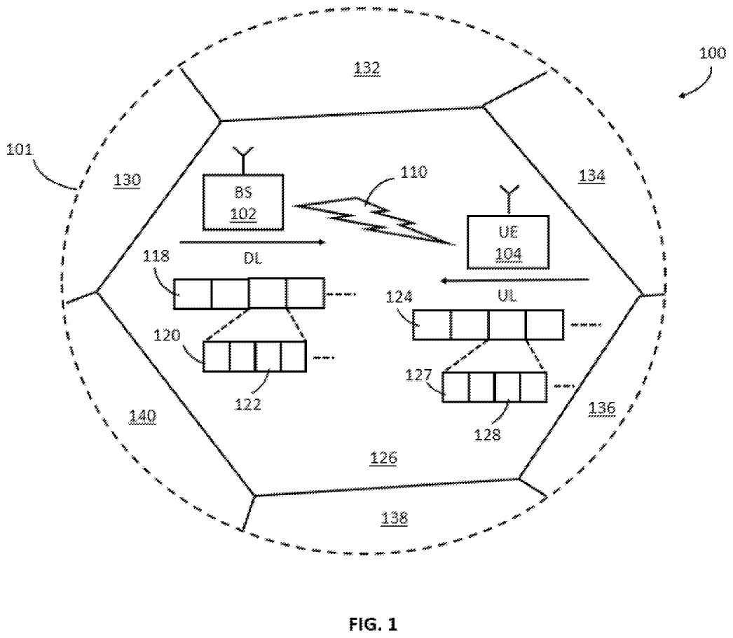

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

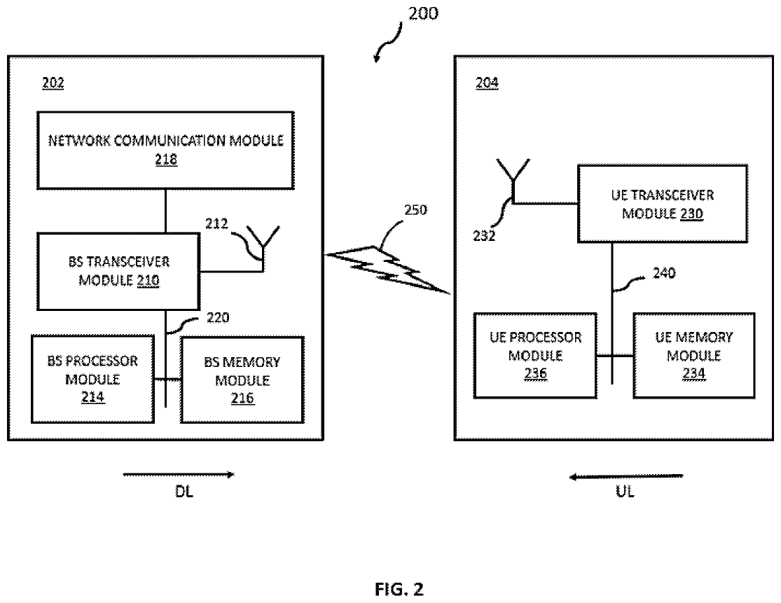

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Location Verification

Non-Terrestrial Network (NTN) user equipment (UE) can be implemented with Global Navigation Satellite System (GNSS) capability and can be configured to obtain/determine its location. However, GNSS based positioning method is radio access technology (RAT) independent. When (e.g., in response to) the network (e.g., base station (BS)) allows/enables/supports the UE to report its location (e.g., for regulatory requirements), the UE may be able to manipulate the reported location, which would make the reported location not reliable/trustable. Hence, how to verify the accuracy of the reported location by the network is a problem that the present disclosure recognizes and provides solutions to address. The systems and methods presented herein include novel approaches for location verification of the UE.

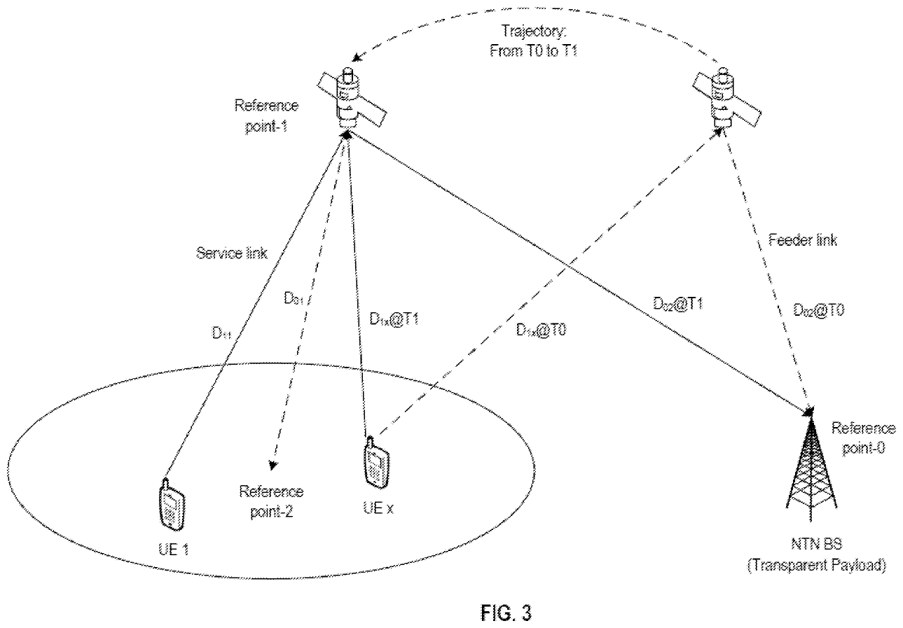

FIG. 3 illustrates an example representation of a transparent NTN. In some embodiments, the link between UE and satellite may be a service link. The link between BS and satellite may be a feeder link. The feeder link delay may be common for all UEs within the same cell. There are mainly two types of location report mechanism. For one of the mechanisms, the UE may report location through non-access stratum (NAS) based mechanism. In this mechanism, the UE can report its location through NAS communication to enable location service. Since the NAS mechanism is performed at a very high layer, the location information may not be reliable/trustable if it is obtained and reported by the UE. For another mechanism, the UE may report its location through a Msg5 transmission in a random access procedure. In this mechanism, UE can report a coarse location through access stratum (AS) signaling. However, if the location information is obtained by a higher layer indication or RAT independent methods, it is still considered not reliable/trustable. In certain embodiments, the UE location may be obtained by RAT independent GNSS positioning.

In NTN, timing advance (TA) pre-compensation can be applied for uplink (UL) synchronization to handle the large propagation delay. The network can indicate a satellite (or other reference point) position (e.g., location coordinates or satellite ephemeris) to UE. As a result, a UE can estimate the service link delay through geometric calculation based on its own location obtained by GNSS positioning and the satellite position indicated from the network (e.g., from a BS). Moreover, TA reporting can also be supported since the network should know the pre-compensated TA at a UE to better arrange scheduling of transmissions/communications. In some embodiments, a UE should report its pre-compensated TA when configured by the network or triggered by a certain event. In certain embodiments, the TA pre-compensation and the TA report are physical layer based, which is more reliable/trustable than the methods related to higher layer(s). Moreover, without proper TA pre-compensation, the uplink (UL) synchronization can be lost. Therefore, the network can obtain a reliable/trustable service link TA, which corresponds to the round trip time/delay (RTT) between a satellite (or other reference point) and a UE, based on the TA report. It would be reasonable to utilize the reported TA to verify the location information reported by a UE.

### Implementation Example 1

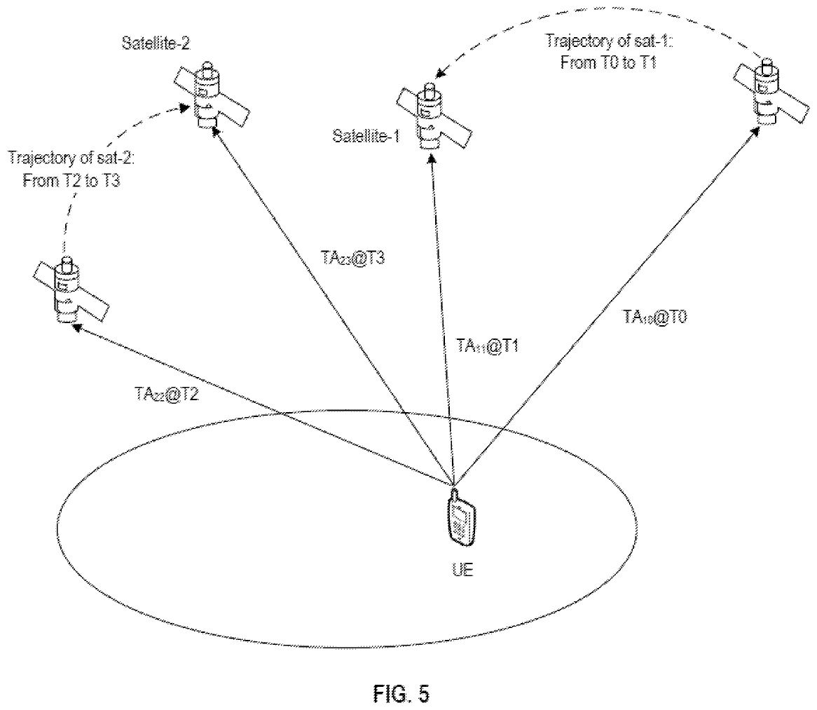

In some embodiments, the reported pre-compensated TA values from a UE can be considered/assumed to be reliable/trustable. Moreover, the service link TAs corresponding to a RTT between a satellite and a UE can be used to estimate the UE's position/location as shown in FIG. 5. Hence, the reported TA can be included as a type of assistance information for location verification. In some embodiments, reporting a TA can be generalized to reporting time information, wherein the time information may comprise at least one of a TA value (of the UE in relation to a reference point), a RTT value (of the UE in relation to a reference point), a single trip delay value (of the UE in relation to a reference point), a difference between values associated with different reference points, or a time instant corresponding to generation of the assistance information. In certain embodiments, the time information may represent a time delay between a wireless communication device (e.g., a UE, a terminal, or a served node) and a reference point. The reference points can either be real positions of satellites or any space/location/position points (including virtual points/objects) indicated/identified/configured by the network (e.g., by the BS).

### A. Method—1

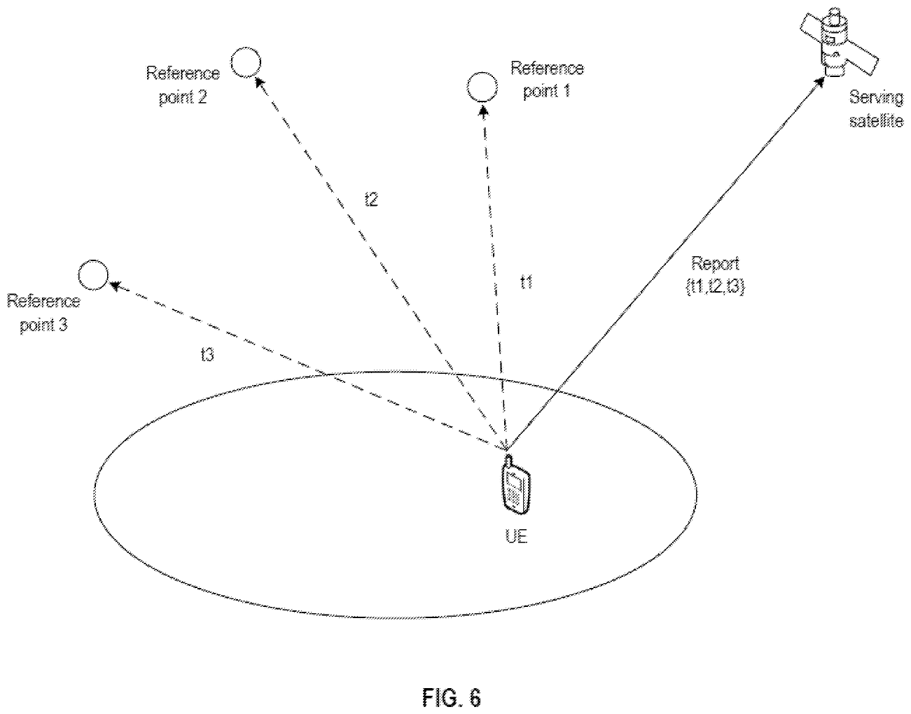

Referring now to FIG. 5, the network can configure a UE with multiple reference points (e.g., for reporting time information). In some embodiments, a UE can report corresponding TA values or other time information of the multiple reference points, to the network. When using this method, it may be assumed that the physical layer of communication system is reliable/trustable. That is, the UE can correctly receive (e.g., be informed of) the reference points indicated by network and does not manipulate the estimated/calculated time information (e.g., RTT values between UE and reference points) that can be reported to the network. With this assumption, the UE can report reliable/trustable time information corresponding to the reference points configured by network, no matter whether the reference points are real satellite positions (e.g., as shown in FIG. 5) or just space points (e.g., as shown in FIG. 6). Note that in FIG. 6, t1-t3 are time information corresponding to reference points 1-3, respectively, which may be TA values, RTT values, or single trip delays, etc.

In some embodiments, the wireless communication device may receive an indication (e.g., positions/locations/coordinates/indices/ephemeris) of a plurality of reference points from the wireless communication node, and can send the assistance information comprising a plurality of time information each corresponding to a respective one of the plurality of reference points, to the wireless communication node.

In some embodiments, additional signaling may be defined/generated/sent for indicating reference points to a UE, unless for instance that all the reference points are pre-defined or are actual available satellites whose ephemeris can be obtained by the UE through signaling. For instance, a UE may receive the reference point information from the network through radio resource control (RRC) signaling, or a system information block (SIB) signaling. After receiving a trigger signaling for location verification, a UE may determine the time information corresponding to the reference points and can report them in/using configured/scheduled time and frequency resources.

### B. Method—2

In some embodiments, a UE may obtain/receive satellite positions based on broadcast/available ephemeris, and/or can report TA pre-compensation values applied in UL synchronization through corresponding satellites to the network. If a UE does not apply/report a correct TA pre-compensation value, UL synchronization can be lost leading to communication failure/issues (which can indicate that the corresponding location information reported by the UE is incorrect/unreliable/untrustable). Hence, it can be assumed that the UE reports TA pre-compensation values that are actually applied in UL synchronization, instead of assuming that estimated TA values are not manipulated, since the UE cannot access the network with wrong TA pre-compensation values. In other words, the assumption for this method is more relaxed than the assumption for Method—1.

In certain embodiments, the TA pre-compensation values should be reported through corresponding satellites at corresponding time instants, e.g., as shown in FIG. 5, to verify whether the corresponding reported TA values are accurate enough by the quality of the corresponding UL synchronization. Hence, if multiple satellites are available, a UE can connect to multiple satellites to perform the location verification. If only very few or even one satellite is available, a UE can report multiple TA values corresponding to different time instants (e.g., of the few satellites or one satellite) to provide enough data for location estimation and/or location verification.

In some embodiments, the wireless communication device may determine a first position of a first satellite according to an ephemeris of the first satellite. The wireless communication device may determine time information corresponding to the first position of the satellite according to the first position, and may send the assistance information comprising the time information, corresponding to the first position of the first satellite, to the wireless communication node via the first satellite. In some embodiments, the wireless communication device may send the assistance information comprising time information, corresponding to a position of the second satellite to the wireless communication node via a second satellite, or may send the assistance information comprising another time information, corresponding to a second position of the first satellite to the wireless communication node via the first satellite.

### C. Method—3

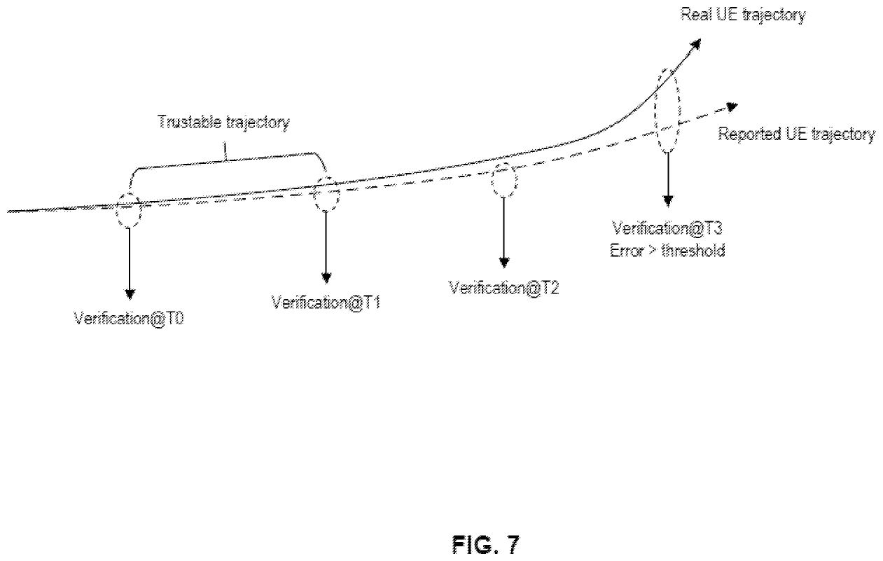

In some embodiments, s UE may report a trajectory (or trajectory information) and/or mobility status of the UE, to assist the base station in performing location verification in high mobility scenario for instance. This can be an add-on method, which can be combined with Method-1 or Method—2 for example. In high mobility scenario (e.g., a UE with significant movement, for instance relative to one or more reference location), the cost of location reporting and location verification can be greatly increased relative to a zero/low mobility scenario. To reduce this cost, the trajectory and mobility status can be reported to the base station (or network). The network can periodically verify the trajectory and/or mobility status based on the time information (e.g., TA values) reported by the UE, as shown in FIG. 7, based on Method—1 or Method—2 for example. If the reported time information can verify the UE's location predicted by trajectory and/or mobility status, e.g., at TO in FIG. 7, the trajectory and/or mobility status of the UE can be considered trustable for a period. During the trustable period, the network may be able to predict and/or verify the UE's location based on the trajectory and mobility status. instead of letting the UE frequently report updated locations and/or time information (e.g., TA pre-compensation values). If the error between a predicted UE location based on reported trajectory and/or mobility status, and an actual/real reported UE location is larger than a threshold (e.g., at T3 in FIG. 7), the reported assistance information (e.g., time information, trajectory and/or mobility status) is considered to be not (or no longer be) reliable/trustable. The network may let/request/instruct the UE to report a newest/updated assistance information for current location verification and/or subsequent location verification.

In some embodiments, the wireless communication device may receive a first indication (e.g., an indication that the trajectory information and the mobility status of the UE is trustable for a period of time, during which the wireless communication device (e.g., UE) does not have to send any new/updated TA value to the wireless communication node) if the location verification by the wireless communication node is successful. The wireless communication device can send a second time information (e.g., different from the first time information) at a defined time, wherein the wireless communication node may perform a second location verification using: the second time information, the trajectory information and/or the mobility status, in response to the first indication. In some embodiments, the defined time can refer to a time instant configured by network or a pre-defined time instant known by both UE and network.

Moreover, the periodic verification for trajectory can be further extended more generally or to all scenarios. If the (reported location information of the) UE passes the location verification, the network may associate a flag/status to the UE and can consider that the UE (or its reported location information) is reliable/trustable for a period of time. During the reliable/trustable period, the network can rely on or trust the UE and not verify the UE's reported location. The trustable period may have a defined length, or may extend across infinity whole duration of a connection between the UE and the network/BS. This method can reduce the frequency and/or cost of c verification. For example, if the location verification is performed in at an initial stage of the UE accessing or connecting to the network, the network can associate the trustable flag/status to UE. Following this and while in connection mode with the network, the UE can be considered to be reliable/trustable, and location verification for the UE's location reports in connection mode and/or after cell-reselection/handover can be avoided.

### Implementation Example 2—Assistance Information for Location Verification

At least one aspect of the following is directed to a system, method, apparatus, or a computer-readable medium. In one embodiment, a wireless communication device (e.g., UE) may send at least one message to a wireless communication node (e.g., BS (can be via a satellite, etc)). In some embodiments, the at least one message may comprise assistance information for the wireless communication node to perform location verification to verify that the location information reported by the UE is reliable/correct/consistent/trustable. In some embodiments, the assistance information may comprise time information (e.g., in relation to a satellite, BS or other reference point/location/coordinates). In some embodiments, the time information may comprise at least one of: a timing advance (TA) value, a round trip time (RTT) value, a single trip delay value, a difference between values associated with different reference points, or a time instant corresponding to generation of the assistance information. In certain embodiments, the time information may represent/comprise/indicate a time delay between a wireless communication device (e.g., a UE, a terminal, or a served node) and a reference point. The reference points can either be real positions of objects (e.g., satellites) or any space points (e.g., location/position) configured by the network.

In various embodiments, the assistance information reported by the UE for location verification can include time information. In certain embodiments, the assistance information may comprise at least one of trajectory information of the wireless communication device and/or mobility status of the wireless communication device. In some embodiments, the mobility status of the wireless communication device may comprise at least one of: a speed, a movement direction, a velocity vector, or an indication (e.g., index or bit field value) of a speed range (e.g., as shown in Table 1), of the wireless communication device. In some embodiments, signaling overhead can be reduced by indicating a speed range instead of an actual/detailed value of speed (e.g., of the UE).

TABLE 1

| Bit field value | Speed range | |
|---|---|---|
| 00 | [0, 60] | km/h |
| 01 | (60, 120] | km/h |
| 10 | (120, 500] | km/h |
| 11 | (500, 1500] | km/h |

TA pre-compensation values reported for location verification may have a different granularity compared with TA pre-compensation values reported for other usage (e.g., for scheduling). The network can indicate to a UE the positions of reference points for estimation of time information (e.g., TA value) at/by the UE. Moreover, the UE may report time information as assistance information to be used by the BS for location verification. For instance, the accuracy and reliability of a reported trajectory may generally decrease over time. As such, the time instant when the trajectory is generated/reported can be helpful for the network to verify the reliability of reported information (e.g., the trajectory).

In some embodiments, the wireless communication device may receive information including at least one of: a position of a reference point for the location verification, a mobility status of a reference point for the location verification, an ephemeris of a satellite for the location verification, a trigger to initiate the location verification, a result of the location verification, at least one type of information to be reported by the wireless communication device to the wireless communication node, a reporting method for the wireless communication device to report the at least one type of information, a schedule for the wireless communication device to report the at least one type of information, a window for the location verification, or a maximum number of times for re-sending information (comprising at least one of: the location information or the assistance information), from the wireless communication node via at least one signaling. In some embodiments, the window for the location verification may comprise at least one of: a start time for the window, a duration of the window, or an end time for the window. In some embodiments, prior to receiving a verification successful message (during this window), the UE may not autonomously transmit to the network or give up (RRC) connection with the network.

### Implementation Example 3—the Method(s) of Assistance Information Reporting

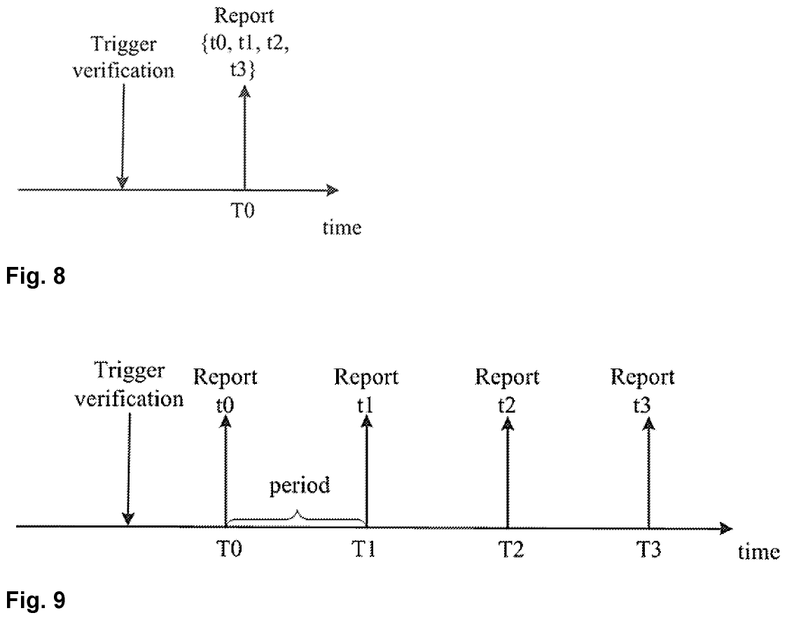

Different methods described herein may require/involve different assistance information reporting approaches. When Method—1 is applied, where a UE cannot manipulate the reported time information, the UE can collect the time information for reference points and report them in one batch or at the same time (e.g., as shown in FIG. 6). Moreover, if the positions of reference points are directly/already indicated to the UE or are known, the UE can simply estimate the time information for these reference points and can report the estimated time information simultaneously as shown in FIG. 8.

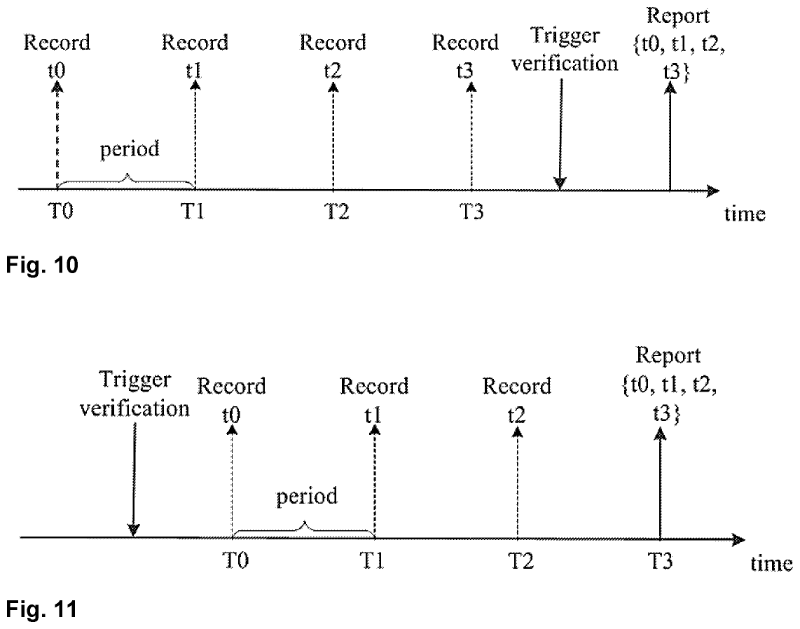

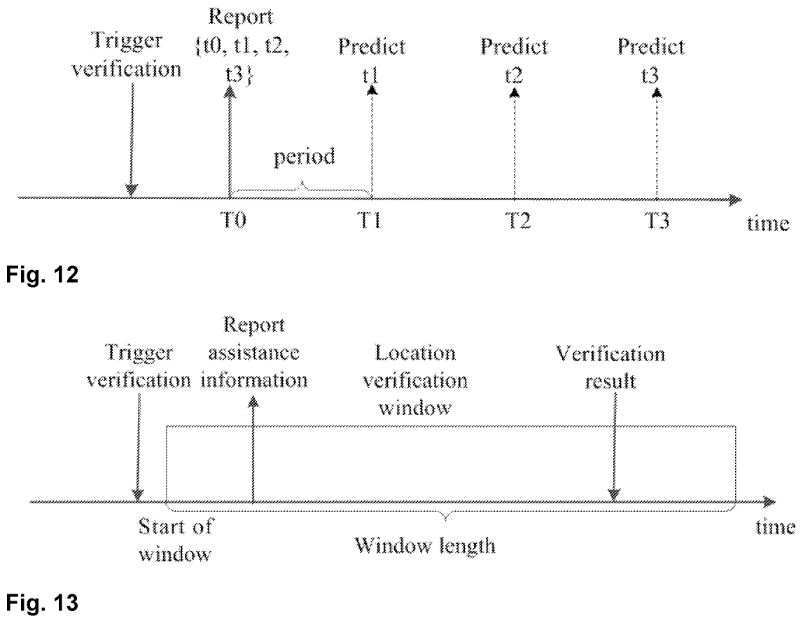

Referring now to FIGS. 9-12, and in some embodiments, if the ephemeris is indicated/available, a UE may further consider at least one of following methods to report useful data: (i) The UE may periodically report the assistance information after triggering location verification as shown in FIG. 9. (ii) The UE may record past assistance information (e.g., past TAs) and report a series of assistance information in one batch or at a same time after/when location verification is triggered. The assistance information can be recorded at time instants in accordance with a certain period for instance, as shown in FIG. 10. (iii) The UE may record the assistance information from/after a time at which location verification is triggered (e.g., in response to location verification) and can report the assistance information in one batch or at a same time after recording enough data. The assistance information can be recorded at time instants in accordance with a certain period for instance, as shown in FIG. 11. (iv) The UE may predict the assistance information in the future (e.g., based on satellite ephemeris) and can report the predicted assistance information in one batch or at a same time after/when location verification is triggered. The predicted assistance information can correspond to periodic time instants for instance as shown in FIG. 12. In some embodiments, the t0-t3 in FIGS. 9-12 may correspond to different reference points, or different time instants for a same satellite, or different satellites at same time instant, or different satellites at different time instants, for example.

When Method—2 is applied, the periodical reporting approach shown in FIG. 9 can be considered when real-time TA pre-compensation values are involved. This is because if predicted values or previously recorded values are reported in the latter scenario, the network cannot (use TA pre-compensation values to) verify whether these values are manipulated by checking the UL synchronization quality.

In some embodiments, the period/periodicity of reporting/recording/predicting assistance information can be configured as different values for different scenarios. When multiple satellites are available for location verification, a UE can report TA values within a short period or only at one time instant. The network can estimate the location of the UE through a similar way as in a terrestrial network. When there is few satellites available, the period (or periodic cycle/duration) should be long enough to ensure that the satellites positions are well spread/distributed spatially, which can improve the positioning accuracy.

### Implementation Example 4—Location Verification Window

Referring now to FIG. 13, the location verification may require/take a period of time, including signaling and processing delays. However, before finishing/completing location verification, the network cannot justify/verify/confirm whether the reported UE location is reliable/trustable so as to determine whether or not to serve the UE or which core network should be selected to serve the UE. In some embodiments, during the period between triggering and finishing of location verification for example, the UE cannot autonomously/unilaterally send signaling and/or data that cannot be handled by network, but may be expected to keep/maintain the RRC connection with the BS, and wait for the result of the location verification—the UE's behavior/state during this period can be described as a verification state. A location verification window can be defined to indicate a time duration within/during which the UE can stay in the verification state (e.g., as shown in FIG. 13). Note that the configuring and triggering of location verification may not be indicated/implemented in the same signaling. For instance, the reference position information, reporting method, etc., may be configured early, e.g., when UE decodes the system information (SI) of the cell or when indicated via RRC signaling after the UE accesses the network. When the signaling for triggering location verification is received, the UE may then start to report the assistance information to the network for location verification.

In some embodiments, the location verification may either happen when the UE performs initial access or during RRC_CONNECTED mode. For location verification when performing initial access, the UE's location may be reported in a msg5 transmission. In some embodiments, the UE may directly report the assistance information for verification along with its location information in a msg5 transmission, and can start the location verification window. In some embodiments, a UE may only report the location information in a msg5 transmission and continue with normal communication/operation. When location verification is triggered by the network (e.g., by a BS), the UE can start the location verification window when the reporting of assistance information starts/ends. In some embodiments, a UE may only report the location information in a msg5 transmission, and can continue with normal communication/operation (e.g., legacy procedure). When location verification is triggered by network, a UE can start the location verification window at certain time instant configured by network.

In certain embodiments, in the location verification window, a UE may not autonomously transmit to the network unless a verification result is obtained. The following examples of UE behaviors may occur when verification result is obtained during the location verification window: (i) If a UE receives an indication from the BS that location verification has passed (successfully verified) or receives scheduling (e.g., scheduling configuration) for normal transmission, the UE can leave/exit the verification state and can continue normal operation/communication. (ii) If a UE receives scheduling for normal transmission, the location verification can be assumed to have passed or is successful, and the UE can leave the verification state and continue to normal operation/communication. (iii) If a UE receives an indication from the BS that location verification has failed (e.g., is unsuccessful), the UE can go back to (e.g., enter or transition/switch to) idle mode (e.g., disconnect from the network, or end RRC connection). (iv) If a UE receives the indication that location verification has failed, the UE can re-transmit at least one of: the location information or verification assistance information. The UE may continue this re-transmitting when location verification has failed unless at least one of the following occurs/happens: (1) the UE has attempted re-transmission or location verification for N times in the window or (2) the duration of location verification window has ended/expired. The value of N can be configured by the network via SIB/RRC signaling or may be directly predefined/determined/configured at the UE.

In some embodiments, the value of N can be configured by the network via SIB/RRC signaling or directly predefined/determined at UE (e.g., similar to the configuration of location verification window). If no verification result is obtained by the UE prior to the end of the location verification window, the following example UE behavior may apply/occur: (i) the verification is assumed failed and UE can go back to idle mode (e.g., disconnect from the network). (ii) the verification is assumed failed and the UE can re-transmit the location information to attempt/support re-verification. (iii) the verification is assumed passed/successful and the UE can continue legacy procedure (e.g., normal communication/operation) with the BS.

For the network side, following example behavior may occur/apply when verification assistance information is received during/for location verification within the window: (i) if the location verification passes or is successful, the network (e.g., BS) may indicate the pass indication to the UE and can continue legacy procedure (e.g., normal communication/operation) with the UE. (ii) If the location verification passes, the network may directly continue with scheduling (e.g., indicate to the UE time and/or frequency resource(s)) for transmission(s), which implicitly indicate that the location location verification has passed. (iii) If the location verification has failed, the network may indicate the failing/failure indication. (iv) If location verification has failed, the network may configure the UE to re-transmit at least one of: the location information or verification assistance information. (v) If location verification has failed, the network may directly release/end the (RRC) connection with the UE.

In some embodiments, if no verification assistance information is received by the network (e.g., BS) prior to the end of the location verification window, the following example network behavior may occur: (i) The verification is assumed to have passed, and the network can continue with scheduling normal transmission. (ii) The verification is assumed to have failed and the network configures the UE to re-transmit at least one of the location information or verification assistance information. (iii) The verification is assumed to have failed and the network may directly release/end the (RRC) connection with the UE.

In some embodiments, for location verification in connected mode, the UE's location may be reported in/via NAS signaling. Hence, the RAN layer may not know when the location is reported. The location verification procedure may more likely be triggered by the network. The following example approaches may be used/implemented for setting a location verification window. (i) When triggered by the network, the UE may report the assistance information for verification and start the location verification window at the start/end time instant of reporting the assistance information. (ii) When triggered by the network, the UE may report the assistance information for verification and can start the location verification window at a certain time instant configured by the network. In the location verification window, the UE may not autonomously send UL data/signaling unless a verification result is obtained. For UE and network behaviors with respect to the location verification window, the above examples for initial access can be considered.

In certain embodiments, the start of a location verification window may be obtained/determined based on at least one of the following methods/approaches: (1) Pre-defined as the start/end time instant of when the UE's location is reported. (2) Pre-defined as the time instant when location verification is triggered. (3) Pre-defined as the start/end time instant when assistance information for verification is reported by the UE. (4) Configured via/by the wireless communication node (e.g., BS), e.g., through SIB/RRC signaling or downlink control information (DCI) signaling.

In some embodiments, the length of the location verification window may be obtained/determined/configured based on at least one of the following methods/approaches: (1) A predefined value, which may be chosen/selected/identified from a series/list of predefined values for various scenarios. (2) Configured via/by the wireless communication node, e.g., through SIB/RRC signaling or downlink control information (DCI) signaling.

Within/during a location verification window, a UE shall not autonomously send UL data and/or signaling that cannot be handled by network unless a verification result is obtained. At least one of the following example UE behavior with respect to the location verification window may be implemented/supported to enable one or more of the above examples: (1) Continue legacy procedure (e.g., normal communication/operation) when the indication that verification is passed is received. (2) Continue legacy procedure when a scheduling for normal transmission/communication from the BS is received. (3) Go back to (e.g., enter or transition to) idle mode when the indication that verification has failed is received. (4) Re-transmit at least one of location information or verification assistance information when the indication that verification has failed is received. (5) Continue legacy procedure if no verification result is obtained by the end of location verification window. (6) Go back to idle mode if no verification result is obtained by the end of the location verification window. (7) Re-transmit at least one of location information and verification assistance information if no verification result is obtained by the end of location verification window.

For network behaviors with respect to the location verification window, at least one of the following may be supported/implemented to enable one or more of the above examples: (1) Indicate that the verification has passed to the UE if the verification has passed. (2) Continue with scheduling normal transmission/communication if the verification has passed. (3) Indicate that the verification has failed to the UE if the verification has failed. (4) Configure the UE to re-transmit at least one of location information or verification assistance information if the verification has failed. (5) Release the connection if the verification has failed. (6) Continue with scheduling normal transmission/communication if no verification assistance information is received by the end of the location verification window. (7) Configure the UE to re-transmit at least one of location information or verification assistance information if no verification assistance information is received by the end of the location verification window. (8) Release the connection if no verification assistance information is received by the end of location verification window.

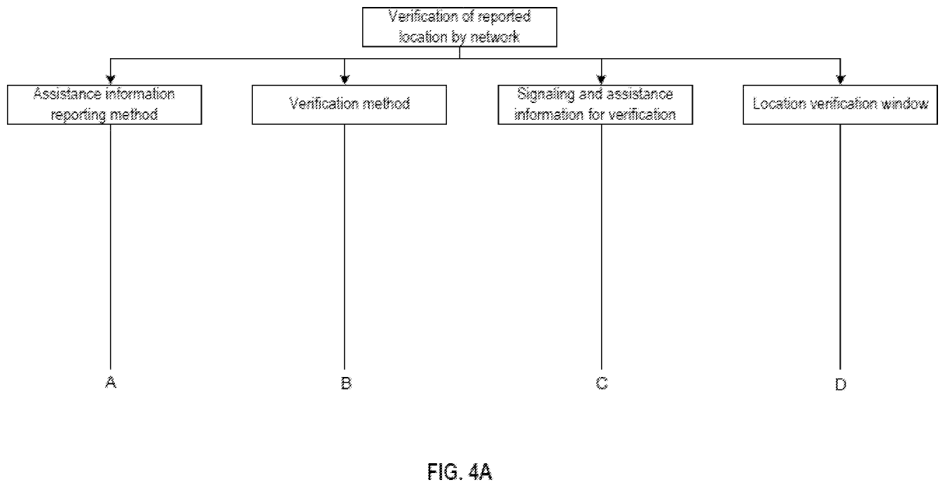

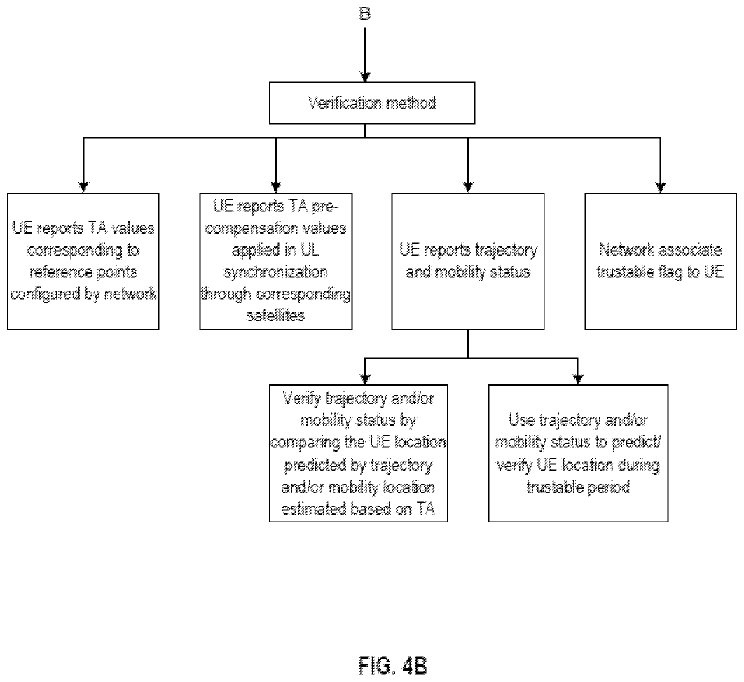

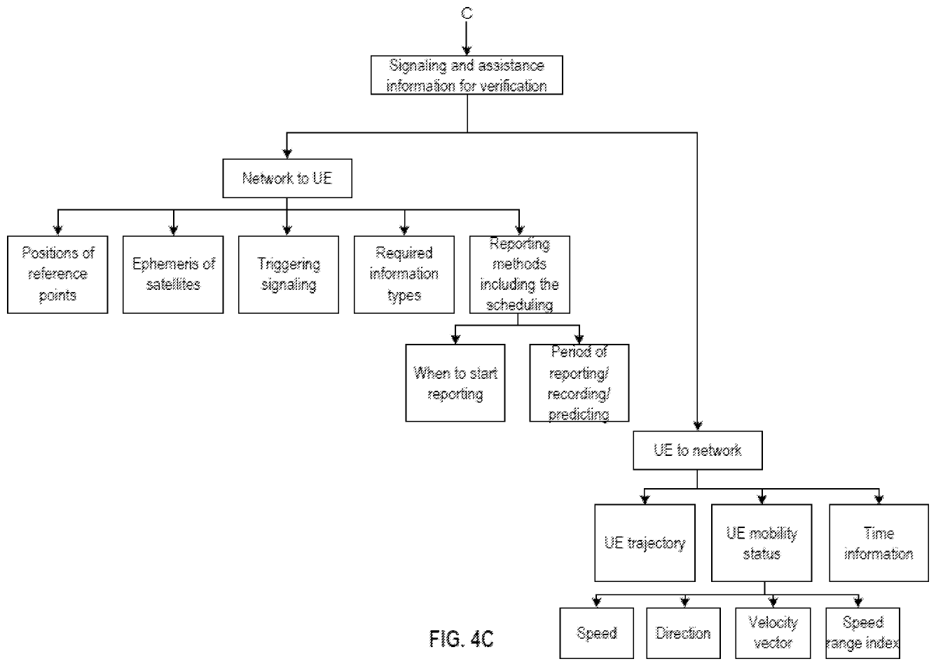

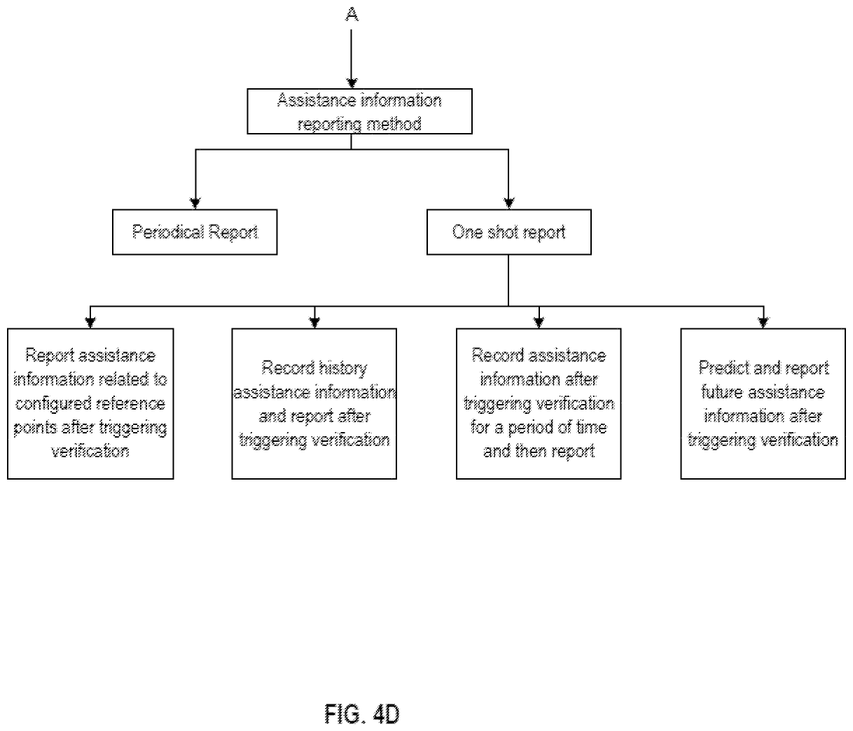

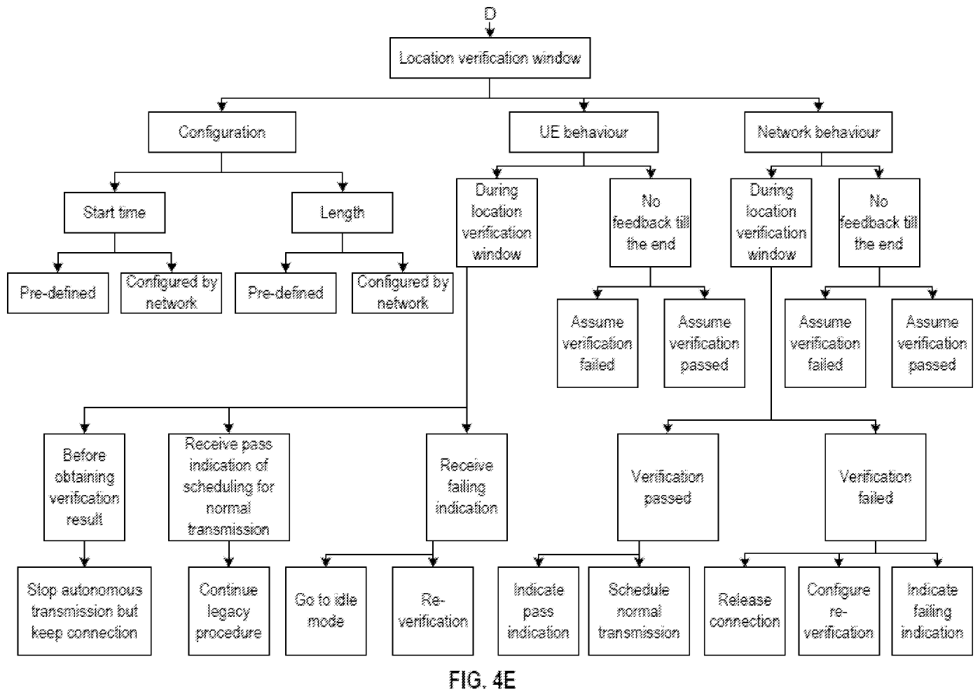

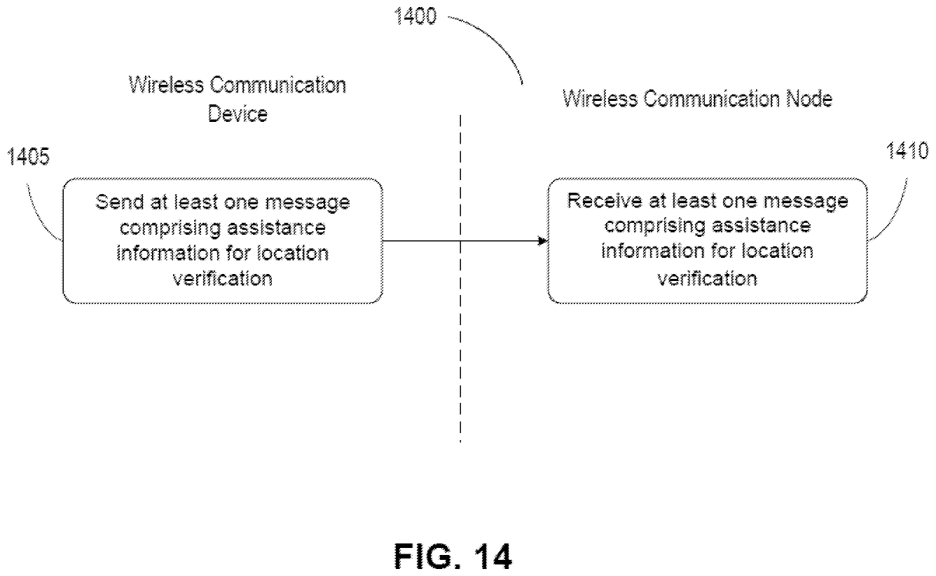

FIG. 14 illustrates a flow diagram of a method 1400 for initiating location verification. The method 1400 may be implemented using any of the components and devices detailed herein in conjunction with FIGS. 1-13. In overview, the method 1400 may include sending/receiving at least one message comprising assistance information to perform location verification (1405).

Referring to (1405), and in some embodiments, a wireless communication device (e.g., UE) may send/transmit to a wireless communication node (e.g., to a BS, via a satellite for instance) at least one message comprising assistance information for the wireless communication node to perform location verification. The wireless communication node can receive from the wireless communication device the at least one message comprising assistance information for the wireless communication node to perform location verification. The location verification may comprise verifying/checking that the location information reported by the wireless communication device is correct/consistent/trustable. The assistance information may include time information (e.g., relative to a satellite, BS or other reference point/location/coordinates). The time information can include at least one of: a timing advance (TA) value, a round trip time (RTT) value, a single trip delay value, a difference between values associated with different reference points, or a time instant corresponding to generation of the assistance information.

The assistance information may include at least one of: trajectory information of the wireless communication device, or mobility status of the wireless communication device. The mobility status of the wireless communication device can comprises at least one of: a speed, a movement direction, a velocity vector, or an indication (e.g., an index) of speed range, of the wireless communication device.

In some embodiments, the wireless communication device may receive from the wireless communication node via at least one signaling, at least one of: a position of a reference point for the location verification, a mobility status of a reference point for the location verification, an ephemeris of a satellite for the location verification, a trigger to initiate the location verification, a result of the location verification, at least one type of information to be reported by the wireless communication device to the wireless communication node, a reporting method for the wireless communication device to report the at least one type of information, a schedule for the wireless communication device to report the at least one type of information, a window for the location verification (e.g., during which a UE shall not attempt to request BS for information or send data that the BS cannot process, or give up a connection with the network, prior to receiving a verification result), or a maximum number of times for re-sending information comprising at least one of: the location information or the assistance information. The reference point can be a virtual reference point, or an actual object (e.g., a satellite, a plane, a drone, a High Altitude Platform Station (HAPS)). Even if the reference point can move, e.g., a satellite or a drone, the mobility status can also be indicated/sent/reported to the wireless communication node.

In some implementations, the window for the location verification comprises at least one of: a start time for the window, a duration of the window, or an end time for the window. The at least one signaling can include: a radio resource control (RRC) signaling, or a system information block (SIB) signaling, or some other signaling.

In one example, the wireless communication device can receive/obtain from the wireless communication node an indication (e.g., positions, locations, coordinates, indices) of a plurality of reference points. The wireless communication device can send to the wireless communication node the assistance information comprising a plurality of time information, each corresponding to a respective one of the plurality of reference points.

In some embodiments, the wireless communication device can determine a first position of a first satellite according to an ephemeris of the first satellite. The wireless communication device can determine according to the first position, time information (e.g., TA precompensation value for a TA value) corresponding to the first position of the satellite (and/or corresponding to the same position or time instance of the TA value and the TA precompensation value). The wireless communication device may send to the wireless communication node via the first satellite (e.g., the satellite corresponding to the TA pre-compensation value), the assistance information comprising the time information (e.g., TA value, and TA precompensation value), corresponding to the first position of the first satellite. The wireless communication device may send to the wireless communication node via a second satellite, the assistance information comprising time information (e.g., TA value, and TA precompensation value), corresponding to a position of the second satellite. The wireless communication device may send to the wireless communication node via the first satellite, the assistance information comprising another time information, corresponding to a second position (and/or a second time instance) of the first satellite.

The wireless communication device may receive from the wireless communication node, a first indication (e.g., an indication that the trajectory information and/or the mobility status of the UE is trustable for a period of time, during which the UE does not have to send any new time/assistance information) if the location verification by the wireless communication node is successful. The wireless communication device may send, in response to the first indication, a second time information at a defined time. In some embodiments, the defined time can refer to a time instant configured by the network or a pre-defined time instant known by both the UE and the network. The wireless communication node can perform a second location verification using the second time information (e.g., second TA value), the trajectory information and the mobility status. For instance, the wireless communication device may compare the second TA value with one that is projected/estimated using the trajectory information and the mobility status. In some embodiments, the wireless communication device may receive from the wireless communication node, a second indication to send updated assistance information, if the second location verification is unsuccessful.

The wireless communication node can assign to the wireless communication device a first flag/state (e.g. an indication that the UE is trustable for a period of time, during which the BS does not perform further location verification) if the location verification by the wireless communication node is successful. Additionally or alternatively, the wireless communication node can determine/decide to skip subsequent local verification of the wireless communication device for at least one of: a defined period, or a duration of a connection with the wireless communication device.

In some embodiments, the wireless communication device receives from the wireless communication node at least one of: a trigger to initiate the location verification, or an indication of a plurality of reference points. The wireless communication device may determine/estimate a plurality of time information corresponding to the plurality of reference points. The wireless communication device may send, to the wireless communication node, the plurality of time information, at a defined time. The defined time can be a configured/predefined time, which can be a time after triggering/initiating the location verification for example. For instance, the defined time can be a time instant configured by the network (e.g., BS) or a pre-defined time instant known by both the UE and the network.

The wireless communication device can, in some embodiments, receive from the wireless communication node, at least one of: a trigger to initiate the location verification, or an indication of a plurality of time instants. The wireless communication device can determine and/or send to the wireless communication node in a periodic manner, a plurality of time information each at a respective time instant (e.g., a configured/predefined time, which can be a time after triggering/initiating the location verification) of the plurality of time instants. The plurality of time instants can be indicated by a start time, a period and/or an end time. For instance, the plurality of time instants can be periodic in nature, and can be determined by a start time instant and a period instead of being indicated as individual time instants.

In one implementation, the wireless communication device determines (e.g., estimates, calculates, records) a plurality of time information each corresponding to one of a plurality of time instants. The wireless communication device may determine and/or send to the wireless communication node, the plurality of time information, at a defined time. In some embodiments, the wireless communication device determines (e.g., calculates and/or records), responsive to the trigger, a plurality of time information each corresponding to one of a plurality of time instants. The wireless communication device may send to the wireless communication node the determined plurality of time information, at a defined time occurring after plurality of time instants.

In some implementations, the wireless communication device predicts, responsive to the trigger, a plurality of time information each corresponding to one of a plurality of time instants. The wireless communication device can send to the wireless communication node the determined plurality of time information, at a defined time occurring prior to the plurality of time instants.

Within a time window prior to successful completion of the location verification, the wireless communication device can operate in a verification state during which the wireless communication device can refrain from unilaterally/autonomously transmitting to the wireless communication node, and/or ending a radio resource control (RRC) connection with the wireless communication node. The time window can start after the wireless communication device sends the first message and location information of the wireless communication device. The time window can start responsive to a start or end time of the sending of the first message. Alternatively, the time window can start at a time configured by the wireless communication node. In some embodiments, if the wireless communication device receives an indication that the location verification is successful or receives a scheduling for a transmission, the wireless communication device may determine to resume normal communication or legacy procedure (e.g., exit the verification state). If the wireless communication device receives an indication that the location verification is unsuccessful, the wireless communication device can determine to: transition to idle mode, or re-send information comprising at least one of: the location information or the assistance information.

The wireless communication device may re-send the information until at least one of: the location verification or re-transmission has been attempted a defined number of times, or the time window has ended/expired. The defined number of times can be a threshold number, or may be predefined/determined by the wireless communication device, or a number configured via RRC/SIB signaling for instance. If the wireless communication device fails to receive a result of the location verification prior to an end of the time window, the wireless communication device may assume that the verification has failed, and may transition to an idle mode. If the wireless communication device fails to receive a result of the location verification prior to an end of the time window, the wireless communication device may assume that the verification has failed, and may re-send information comprising at least one of: the location information or the assistance information. If the wireless communication device fails to receive a result of the location verification prior to an end of the time window, the wireless communication device may assume that the verification is successful, and may resume normal communication (e.g., legacy procedure).

In some embodiments, if the location verification is successful, the wireless communication node can send an indication to the wireless communication device that the location verification is successful. If the location verification is successful, the wireless communication node can schedule a transmission with the wireless communication device. If the location verification is unsuccessful, the wireless communication node can send an indication to the wireless communication device that the location verification is unsuccessful. If the location verification is unsuccessful, the wireless communication node can configure or indicate the wireless communication device to re-send information comprising at least one of: the location information or the assistance information. If the location verification is unsuccessful, the wireless communication node can release or terminate a connection with the wireless communication device.

In some implementations, if the assistance information is not received prior to an end of the time window, the wireless communication node can assume that the verification is successful, and can schedule a transmission with the wireless communication device. If the location verification is unsuccessful, the wireless communication node can assume that the verification is unsuccessful, and can release or terminate a connection with the wireless communication device. If the location verification is unsuccessful, the wireless communication node can assume that the verification is unsuccessful, and can configure or indicate the wireless communication device to re-send information comprising at least one of: the location information or the assistance information.

In some embodiments, a start of the time window is one of: predefined as a start or end time for the wireless communication device to send the location information, predefined as a time instant of triggering the location verification, predefined as a start or end time for the wireless communication device to send the assistance information, or configured via the wireless communication node. A length of the time window can be one of: a value selected from at least one predefined values, or configured via the wireless communication node.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
sending, by a wireless communication device to a wireless communication node, at least one message comprising assistance information for the wireless communication node to perform location verification,
wherein the assistance information comprises time information.

2. The method of claim 1, wherein the assistance information further comprises at least one of:
trajectory information of the wireless communication device, or
mobility status of the wireless communication device.

3. The method of claim 2, wherein the mobility status of the wireless communication device comprises at least one of: a speed, a movement direction, a velocity vector, or an indication of speed range, of the wireless communication device.

4. The method of claim 1, comprising:
receiving, by the wireless communication device from the wireless communication node via at least one signaling, at least one of:
a position of a reference point for the location verification,
a mobility status of a reference point for the location verification,
an ephemeris of a satellite for the location verification,
a trigger to initiate the location verification,
a result of the location verification,
at least one type of information to be reported by the wireless communication device to the wireless communication node,
a reporting method for the wireless communication device to report the at least one type of information,
a schedule for the wireless communication device to report the at least one type of information,
a window for the location verification, or
a maximum number of times for re-sending information comprising at least one of:
the location information or the assistance information.

5. The method of claim 4, wherein the window for the location verification comprises at least one of: a start time for the window, a duration of the window, or an end time for the window.

6. The method of claim 4, wherein the at least one signaling comprises: a radio resource control (RRC) signaling, or a system information block (SIB) signaling.

7. The method of claim 4, comprising:
receiving, by the wireless communication device from the wireless communication node, an indication of a plurality of reference points; and
sending, by the wireless communication device to the wireless communication node, the assistance information comprising a plurality of time information each corresponding to a respective one of the plurality of reference points.

8. The method of claim 4, comprising:
determining, by the wireless communication device, a first position of a first satellite according to an ephemeris of the first satellite;
determining, by the wireless communication device according to the first position, time information corresponding to the first position of the satellite; and
sending, by the wireless communication device to the wireless communication node via the first satellite, the assistance information comprising the time information, corresponding to the first position of the first satellite.

9. The method of claim 8, comprising at least one of:
sending, by the wireless communication device to the wireless communication node via a second satellite, the assistance information comprising time information, corresponding to a position of the second satellite; or
sending, by the wireless communication device to the wireless communication node via the first satellite, the assistance information comprising another time information, corresponding to a second position of the first satellite.

10. The method of claim 2, comprising:
receiving, by the wireless communication device from the wireless communication node, a first indication if the location verification by the wireless communication node is successful; and
sending, by the wireless communication device in response to the first indication, a second time information at a defined time, wherein the wireless communication node performs a second location verification using the time information, the trajectory information and the mobility status.

11. The method of claim 10, comprising:
receiving, by the wireless communication device from the wireless communication node, a second indication to send updated assistance information, if the second location verification is unsuccessful.

12. The method of claim 1, wherein the wireless communication node at least one of:
assigns to the wireless communication device a first flag if the location verification by the wireless communication node is successful, or
determines to skip subsequent local verification of the wireless communication device for at least one of: a defined period, or a duration of a connection with the wireless communication device.

13. The method of claim 1, comprising:
receiving, by the wireless communication device from the wireless communication node, an indication of a plurality of reference points;
determining, by wireless communication device, a plurality of time information corresponding to the plurality of reference points; and
sending, by the wireless communication device to the wireless communication node, the plurality of time information, at a defined time.

14. The method of claim 1, comprising:
receiving, by the wireless communication device from the wireless communication node, an indication of a plurality of time instants; and
sending, by the wireless communication device to the wireless communication node in a periodic manner, a plurality of time information each at a respective time instant of the plurality of time instants.

15. The method of claim 1, comprising:
determining, by wireless communication device, a plurality of time information each corresponding to one of a plurality of time instants; and
sending, by the wireless communication device to the wireless communication node, the plurality of time information, at a defined time.

16. The method of claim 1, comprising:
determining, by wireless communication device responsive to the trigger, a plurality of time information each corresponding to one of a plurality of time instants; and
sending, by the wireless communication device to the wireless communication node, the determined plurality of time information, at a defined time occurring after plurality of time instants.

17. The method of claim 1, comprising:
predicting, by wireless communication device responsive to the trigger, a plurality of time information each corresponding to one of a plurality of time instants; and
sending, by the wireless communication device to the wireless communication node, the determined plurality of time information, at a defined time occurring prior to the plurality of time instants.

18. A method comprising:
receiving, by a wireless communication node from a wireless communication device, at least one message comprising assistance information for the wireless communication node to perform location verification,
wherein the assistance information comprises time information.

19. A wireless communication node, comprising:
at least one processor configured to:
receive, via a receiver a from a wireless communication device, at least one message comprising assistance information for the wireless communication node to perform location verification,
wherein the assistance information comprises time information.

20. A wireless communication device, comprising:
at least one processor configured to:
send, via a transmitter to a wireless communication node, at least one message comprising assistance information for the wireless communication node to perform location verification,
wherein the assistance information comprises time information.
